(19) United States
(12) Patent Application Publication
(10) Pub. No.: US 2022/0059813 A1
(43) Pub. Date: Feb. 24, 2022

(54) Structured metal electrode and combination thereof with non-liquid electrolytes

(71) Applicants: Westfälische Wilhelms-Universität Münster, Münster (DE); Forschungszentrum Jülich GmbH, Jülich (DE)

(72) Inventors: Martin WINTER, Münster (DE); Hans-Dieter WIEMHÖFER, Münster (DE); Martin FINSTERBUSCH, Jülich (DE); Yulia ARINICHEVA, Aachen (DE); Peter Maria BIEKER, Hamm (DE); Kirsi JALKANEN, Espoo (FI); Dominik LIEBENAU, Münster (DE); Martin KOLEK, Münster (DE); Jens BECKING, Münster (DE); Marian Christian STAN, Hamm (DE); Sebastian SCHMOHL, Münster (DE); Paulo SCHMITZ, Niederlangen (DE)

(21) Appl. No.: 17/292,171

(22) PCT Filed: Nov. 6, 2019
(86) PCT No.: PCT/EP2019/080425

§ 371 Date: Nov. 2, 2021

(30) Foreign Application Priority Data
Nov. 7, 2018 (DE) 10 2018 127 787.3

(51) Int. Cl. H01M 4/134; H01M 10/0565; H01M 4/04; H01M 4/1395; H01M 4/66

(52) U.S. Cl. CPC H01M 4/134; H01M 10/0565; H01M 4/0435; H01M 2300/0071; H01M 4/667; H01M 2300/0082; H01M 2300/0094; H01M 4/1395

(57) ABSTRACT

The disclosure relates to a metal electrode or current collector for an energy storage device. The surface of the electrode or the current collector includes multiple blind hole-like recesses spaced apart from each other. The surface structured in this way is coated with a solid polymer electrolyte. The recesses are filled with the solid polymer electrolyte, as well as a primary or secondary energy storage device including the same.

The invention relates to the field of electrochemical energy storage devices. In particular, the invention relates to a structured metal electrode and its use in combination with non-liquid electrolytes.

Metal batteries based on metals such as iron, sodium, calcium, magnesium, aluminum or lithium offer the advantage over conventional lithium-ion batteries that higher theoretical energy densities can be achieved. Lithium-air batteries in particular have high specific capacity and energy. In these reversible metal batteries, lithium metal is used as the anode. However, the practical application is not yet fully developed due to, among others, the reactive nature of the lithium metal and a resulting degradation in performance and safety during use. In particular, lithium is a promising electrode material due to a low redox potential, its high capacity and low molecular weight. However, a low cycle stability and safety concerns resulting from dendrite growth on the electrode, in particular at high current densities, are restricting factors for an application. Lithium electrodes can have a high overpotential or overvoltage as well as high cell resistances. Thus, the application of lithium electrodes has so far been limited to primary cells, with a few exceptions.

From document DE 10 2013 114 233 A1 it is already known to structure the surface of a lithium electrode with recesses so that these provide an improved discharge rate, charge rate and cycle stability when used with a liquid electrolyte. DE 10 2014 207 999 A1 further discloses a structured lithium metal anode, wherein the cavities of the structuring are filled with anode material. U.S. Pat. No. 6,576,371 B1 describes a battery comprising a solid electrolyte in which a solid multilayer structure is formed on the positive electrode, wherein one electrolyte layer is significantly softer than further solid electrolyte layers. A structuring of the metal electrode is not described.

In order to exploit the potential of the metal electrodes, further improvements are required. It was thus an object of the present invention to provide a metal electrode exhibiting a lower deposition resistance.

This object is achieved by a metal electrode or a current collector for an energy storage device, in particular an electrochemical energy storage device, wherein the surface of the electrode or the current collector comprises a plurality of mutually spaced, blind hole-like recesses, and wherein the surface thus structured is coated with a solid polymer electrolyte, wherein the recesses are filled with the solid polymer electrolyte.

Surprisingly, it was found that the combination of recesses provided in the surface of the metal electrode or the current collector and a functional coating with a solid polymer electrolyte according to the invention can provide a significant decrease in the deposition voltage or deposition resistance. Thus, a significant reduction of the cell resistance could be shown. This is particularly advantageous in conjunction with the use of non-liquid electrolytes, since the resistance of lithium electrodes against these is generally high. Hereby, the cyclability of metal electrodes, in particular lithium electrodes, comprising non-liquid electrolytes can be significantly improved, and thus the lifetime of a cell can be significantly increased. Furthermore, the functional coating can improve the contact to non-liquid electrolytes such as gel polymers, solid polymers, ceramic solids, glasses and combinations thereof, so-called hybrids. The use of non-liquid electrolytes furthermore improves the safety of the use of a lithium electrode, in particular, increased safety can be provided in the event of malfunction or damage of a battery. Another advantage is that a protected metal electrode with a directional lithium deposition can be provided.

Without being bound to theory, it is believed that the advantages of the invention are based on the combination of structuring and functional coating that promotes the contact between the structured metal electrode. Simple machining principles, which can be transferred to roll-to-roll, can be used for the structuring, while the coating can be applied by use of simple coating techniques. The machining of the electrode or the current collector can be transferred to scalable systems, which can strengthen a commercial interest.

The term “polymer electrolyte” or polymeric electrolyte is to be understood as solutions of salts such as lithium bis(oxalato)borate (LiBOB) in polymers such as poly[bis((methoxyethoxy)ethoxy)phosphazene] (MEEP). In this case, the transport of charge takes place by a movement of the cations, in particular lithium ions of the salt, through the polymer electrolyte. The term “solid polymer electrolyte” is to be understood as a polymer comprising a lithium salt dissolved therein, which is in a solid state of aggregation at room temperature due to cross-linking and does not contain any liquid components such as liquid solvent.

The surface of the electrode in which the recesses and the coating are provided corresponds in an appropriate manner to the side on which an electrolyte is present in a galvanic cell or battery. The surface of the electrode comprises a plurality of recesses, in particular a multiplicity of recesses. The individual recesses are spaced apart from one another, although this does not preclude the possibility that the recesses may not merge into one another as a result of the production of the recesses. The recesses are blind hole-like. In the sense of the present invention the term “blind-hole-like” is to be understood in the sense that the recesses do not completely penetrate the metal electrode, i.e. they comprise a bottom or a tip.

The shape of the recesses or the structuring can be varied. The recesses can have different geometries. For example, the recesses can be rectangular, trapezoidal, calotte shaped or triangular in cross-section. The recesses can be introduced into the metal by forming processes. The recesses can, for example, be introduced by means of embossing processes by use of punches or by means of rollers, in particular calender rollers. Such processes for mechanical structuring are preferred. Moreover, a laser or beam process can be used. Metal films that can be used as electrodes can preferably be produced by rolling the starting material or metal. For lithium, in particular rollers provided with an alloy or coated rollers are used. A punch or a roller, which has a positively structured surface corresponding to the recesses, can introduce the recesses into a metal film of a desired thickness. The shape of the structuring of the punch or roller may be selected from cuboids, cylinders, pyramids, capped cuboids and/or semicircles such that the geometry of the recesses may correspond to inverse cuboids, cylinders, pyramids, capped cuboids and/or semicircles. Preferably, cuboids or pyramidal or cylindrical shapes may be used.

In addition to the shape, for example rectangular or in the form of a pyramid, moreover, the size and the spacing of the tips in the punch or roller can be varied, wherein different structures and surface enlargements can be obtained. For example, the spacing of the structures can be varied. By varying the spacing between the structures different structuring densities are obtained. A higher structuring density increases the total surface area of a lithium electrode, wherein the surface enlargement depends on the defect spacing. In preferred embodiments, the structure surface area of the electrode is enlarged in a range from ≥20% to ≤200%, preferably from ≥30% to ≤150%, more preferably from ≥50% to ≤100%, based on an area of the same dimension with a planar surface. Here, the area with a flat surface is set as 100%.

Furthermore, the positive structures, for example cuboid needles, of the punch or roller can be changed in terms of their length, width and height in order to achieve the effect of larger or smaller structurings. In conjunction therewith, it is possible to reduce the thickness of the electrode material used, such as lithium, with the height of the embossing structure. It is preferred that the recesses have a size in the micrometre range. Structures of a size in the micrometre range can advantageously be produced on a large industrial scale. In preferred embodiments, the recesses have a length, width and/or depth in a range from ≥100 μm to ≤800 μm, preferably in a range from ≥200 μm to ≤500 μm, more preferably from ≥300 μm to ≤400 μm. Thus, for cuboidal recesses, the length, width and depth may be in a range from ≥100 μm×100 μm×100 μm to ≤800 μm×800 μm×800 μm, preferably in a range from ≥200 μm×200 μm×200 μm to ≤500 μm×500 μm×500 μm, more preferably from ≥300 μm×300 μm×300 μm to ≤400 μm×400 μm×400 μm. The structured surface or structured electrode is in particular a microstructured surface or a microstructured lithium electrode.

In further preferred embodiments, the recesses have a depth in a range from ≥25 μm to ≤75 μm, preferably in a range from ≥30 μm to ≤50 μm, more preferably from ≥35 μm to ≤40 μm, and a length and/or width in a range from ≥100 μm to ≤800 μm, preferably in a range from ≥200 μm to ≤500 μm, more preferably from ≥300 μm to ≤400 μm. In particular, for cuboidal recesses, the length, width and depth may be in a range from ≥100 μm×100 μm×25 μm to ≤800 μm×800 μm×75 μm, preferably in a range from ≥200 μm×200 μm×30 μm to ≤500 μm×500 μm×50 μm, more preferably from ≥300 μm×300 μm×35 μm to ≤400 μm×400 μm×40 μm.

The thickness of the metal electrode, such as a lithium film, into which the recesses are embossed, may in this case be in the range from ≥150 μm to ≤800 μm, preferably in the range from ≥300 μm to ≤500 μm. It is further possible to apply, for example press, lithium onto a layer or film of another metal or current collector as a carrier material, for example copper. The metal electrode can therefore also be formed from a lithium layer deposited on a layer of another metal such as copper. Furthermore, the lithium layer can also be applied onto electronically conductive three-dimensional structures such as nets, braids or foams, for example copper braid or copper foam as a carrier material. In this case, the total thickness including lithium and carrier material may be in a range from ≥20 μm to ≤60 μm, preferably from ≥25 μm to ≤40 μm.

In embodiments, the depth of the recesses, based on a total thickness of the metal electrode or lithium layer on a metal, current collector or another structure as carrier material of 100%, may be in a range from ≥30% to ≤70%, preferably in a range from ≥40% to ≤60%, in particular in a range from ≥50% to ≤60%.

The concept of lithium structuring by means of punches or preferably by means of rollers can be transferred to almost any structuring pattern, depending on the precision mechanical limits for punch or roller production. In particular, a structuring by means of rollers has potential for upscaling to an industrial scale. For example, corresponding rolls with tip structuring can be designed for a roll-to-roll process. Materials that are unreactive to lithium, such as polyoxymethylene (POM), polyetheretherketone (PEEK), polyethylene (PE), polypropylene (PP), as well as metals that do not alloy with lithium, such as aluminum, stainless steel or copper, are suitable as materials for block presses or rollers.

The structured surface is coated with a solid polymer electrolyte, which fills the recesses of the surface. In order to wet a structured lithium surface with a non-liquid electrolyte and to fully utilize the enlarged surface area, a functional coating method can be used. For such a coating, a solution is prepared from the components of the electrolyte, a suitable polymer, conducting salt and a preferably UV light-activatable cross-linking additive which are dissolved in a suitable solvent. This solution or mixture can be applied onto the structured lithium surface in order to produce a homogeneous coating. The coated lithium electrodes can be dried at an elevated temperature such that the solvent evaporates and be irradiated with UV light such that the polymer is cross-linked and thereby a coating with a solid polymer electrolyte is formed. By means of this method, a thin layer of polymer electrolyte can be applied onto a structured lithium electrode so that the layer follows the surface pattern and thereby wets the entire surface.

In preferred embodiments, the solid polymer electrolyte comprises a polymer selected from the group comprising poly[bis((methoxyethoxy)ethoxy)phosphazene] (MEEP), poly((oligo)oxethylene)methacrylate-co-alkali metal methacrylate, poly[bis((methoxyethoxy)ethoxy)-co-(lithium-trifluoro-oxoborane)polyphosphazene] (MEE-co-BF₃LiP), polyethylene oxide (PEO), poly(ethylene glycol) dimethyl ether (PEGDME), polystyrene-b-poly(ethylene oxide) (SPE), polyvinylidene fluoride (PVdF), poly(vinylidene fluoride-co-hexafluoropropylene) (PVdF-HFP), polyacrylonitrile (PAN), polyester, polypropylene oxide, ethylene oxide/propylene oxide copolymer, polymethyl methacrylate (PMMA), polymethylacrylonitrile (PMAN), polysiloxane, poly(chlorotrifluoro-ethylene), poly(ethylene-chlorotrifluoro-ethylene) and mixtures thereof. Preferably, MEEP and its derivative MEE-co BF₃LIP, polyethylene oxide (PEO), polyvinylidene fluoride (PVdF), or block copolymers such as polystyrene-b-poly(ethylene oxide) (SPE) can be used as polymers. PEO can additionally be combined with an ionic liquid such as 1-butyl-1-methylpyrrolidinium bis((trifluoromethyl)sulfonyl)imide (Pyr₁₄TFSI) or 1-ethyl-3-methylimidazolium-bis((trifluoromethyl)sulfonyl)imide (Im₁₂TFSI).

In the case of a use with lithium anodes, preferred conducting salts are lithium salts. Preferred lithium salts are those that do not decompose at elevated temperatures of, for example, 100° C. or 120° C. In preferred embodiments, the lithium salt is selected from the group comprising lithium bis(oxalato)borate (LiBOB), LiPF₆, LiBF₄, LiAsF₆, LiClO₄, lithium-bis(trifluoromethane)sulfonimide (LiN(SO₂CF₃)₂, LiTFSI), lithiumbis(fluorosulfonyl)imide (LiN(FSO₂)₂, LiFSI), lithium-difluoro(oxalato)borate (LiDFOB) and/or lithium-triflate (LiSO₃CF₃, LiTf). Particularly preferred lithium salts are selected from the group comprising LiBOB, LiPF₆, LiBF₄, LiAsF₆, LiClO₄, LiTFSI and/or LiFSI, in particular LiBOB, LITFSI, LiPF₆ and LiBF₄.

Preferred crosslinkers are selected from the group comprising benzophenone, divinylbenzene, which is used for polystyrene, and polyhedral oligomeric silsesquioxane (POSS), whose derivative can crosslink amine-functionalised PEO. Preferred solvents are selected from the group comprising tetrahydrofuran (THF), 1,3-dioxolane (DOL), acetonitrile (ACN) and/or adiponitrile (ADP).

A particularly preferred polymer is poly[bis((methoxyethoxy)ethoxy)phosphazene], (MEEP), a preferred lithium salt is lithium-bis(oxalato)borate (LiBOB) and a preferred crosslinking additive is benzophenone. A preferred solvent is tetrahydrofuran (THF).

The amount of polymer in the solid polymer electrolyte layer may be in the range of 10 wt.-% to ≤90 wt.-%, preferably in the range of ≥15 wt.-% to ≤85 wt.-%, more preferably in the range of ≥20 wt.-% to ≤80 wt.-%, based on the total weight of the solid polymer electrolyte. The amount of conducting salt in the solid polymer electrolyte layer may be in the range of ≥6 wt.-% to ≤20 wt.-%, preferably in the range of ≥8 wt. % to ≤16 wt.-%, more preferably in the range of ≥10 wt.-% to ≤12 wt.-%, based on the polymer content of the solid polymer electrolyte. The amount of crosslinker in the solid polymer electrolyte layer may be in the range of ≥5 wt.-% to ≤20 wt.-%, preferably in the range of ≥7 wt.-% to ≤17 wt.-%, more preferably in the range of ≥10 wt. % to ≤15 wt.-%, based on the polymer content of the solid polymer electrolyte.

In preferred embodiments, the solid polymer electrolyte forms a layer with a layer thickness in a range from ≥5 μm to ≤150 μm, preferably from ≥15 μm to ≤100 μm, more preferably from ≥20 μm to s 50 μm. Here, the indication of the layer thickness refers to the thickness of the solvent-removed layer above the surface without taking into account the depth of the recesses. In other words, the solid polymer electrolyte thus forms a continuous layer with a layer thickness in a range from ≥5 μm to ≤150 μm on the surface of the electrode or current collector.

The method for the functional coating is advantageously transferable to other structured or structurable metal electrodes such as lithium alloys, sodium, magnesium or zinc and to current collectors, which are mostly formed from copper or aluminum film. In embodiments of the electrode or the current collector, the metal is therefore selected from the group comprising lithium, sodium, potassium, magnesium, calcium, aluminum, zinc, nickel, copper and/or iron, preferably lithium. In preferred embodiments, the metal of the electrode is selected from the group comprising lithium, sodium, magnesium, calcium, zinc and/or iron. Metal electrodes have a high specific energy. In this respect, zinc and in particular lithium or sodium electrodes are of particular commercial interest. In a particularly preferred embodiment, the metal is lithium. Lithium is a very preferred electrode material due to a low redox potential and a high capacity.

Prior to coating with the functional coating of solid polymer electrolyte, the metal such as lithium can be chemically modified. This can be done, for example, by dip coating in electrolyte additives such as 1-fluoroethylene carbonate (FEC) or vinylene carbonate (VC) or lithium nitrate (LiNO₃) in 1,3-dioxolane (DOL), whereby a protective layer, a so-called SEI (solid electrolyte interphase) can be formed on the metal, in particular lithium. Furthermore, the metal, in particular lithium, can be chemically modified, for example by exposing it to a CO₂ atmosphere, whereby a carbonate layer is formed on the metal. These types of modifications can be combined with the mechanical modifications presented and a non-liquid electrolyte. In preferred embodiments, the metal is lithium, wherein the structured lithium surface has a chemical modification, preferably selected from a lithium ion-conducting layer containing lithium carbonate prepared by contact reactions of a lithium surface with carbon dioxide, 1-fluoroethylene carbonate (FEC), vinylene carbonate (VC) or lithium nitrate (LiNO₃) in 1,3-dioxolane (DOL). Thereby a further stabilisation of the electrode can be achieved. In addition to lithium carbonate, lithium oxide and lithium hydroxide can be a component of the SEI, which is formed by reactions with the various carbonates or with elemental oxygen contained in the atmosphere. Furthermore, lithium fluoride can be generated by reactions with 1-fluoroethylene carbonate (FEC) and lithium nitride can be generated by reactions with lithium nitrate or elemental nitrogen, which are introduced in the SEI. Other chemical components that can be used to build an SEI are metals and polymers, as well as other inorganic compounds such as ceramics. In particular, alloying metals are preferred as components in an SEI. Furthermore, polymers and inorganic components that are stable to the metal electrode and have lithium ion conductivity are preferred components of a protective layer.

The coated, structured metal electrode can be combined with a non-liquid electrolyte. The non-liquid electrolyte may comprise polymers, ceramics or glasses which have a suitable metal-ion conductivity. The structured and coated metal electrode obtained hereby, combined with a solid polymer electrolyte, gel polymer electrolyte, or mixed phase/composite electrolyte, is particularly useful as an anode with suitable cathode materials.

Another object of the invention relates to a primary or secondary energy storage device, in particular an electrochemical energy storage device, comprising a current collector according to the invention or a metal electrode according to the invention, a non-liquid electrolyte and a counter-electrode. The metal electrode according to the invention is preferably the negative electrode (anode) and the counter electrode is correspondingly the positive electrode. The energy storage device is preferably selected from the group comprising a lithium metal battery, a lithium metal accumulator lithium ion accumulator, a lithium polymer battery, a lithium ion capacitor, a super capacitor, hybrid (super) capacitors, a dual ion battery and/or an (earth) alkaline metal ion battery. Preferred are secondary electrochemical energy storage devices.

For the description of the current collector and the electrode, reference is made to the above description. In the sense of the present invention, the term “energy storage device” includes primary and secondary energy storage devices, i.e. batteries (primary storage devices) and accumulators (secondary storage devices). In the current language, accumulators are often referred to by the term “battery”, which is often used as a generic term. The term lithium-ion battery is used synonymously with lithium-ion accumulator unless otherwise stated. In the sense of the present invention, the term “electrochemical energy storage device” also includes electrochemical capacitors, electrochemical double-layer capacitors, super- or ultracapacitors or so-called pseudocapacitors. Electrochemical capacitors, also referred to as supercapacitors in the literature, are electrochemical energy storage devices that are characterized by a higher power density compared to batteries and a higher energy density compared to conventional capacitors.

Hybrid (super) capacitors comprise a combination of power density-optimised and energy density-optimised electrodes. They are mostly asymmetrical capacitors. The power-density-optimised electrode is characterised in particular by a double-layer-based capacitance and the energy-density-optimised side by a so-called pseudo-capacitance, which is primarily derived from Faraday processes. A preferred hybrid supercapacitor is the so-called lithium-ion capacitor. In this capacitor, a lithium intercalation material is used at the negative side and an activated carbon electrode at the positive side. A hybrid supercapacitor is thus a hybrid of battery and capacitor technology.

Electrochemical energy storage devices can be galvanic cells comprising a metal electrode, for example metal-air, metal-sulphur or metal-oxygen batteries or accumulators, or (earth) alkali metal ion accumulators or supercapacitors. Lithium-based energy storage devices are preferred. Lithium-based energy storage devices are preferably selected from the group comprising lithium batteries, lithium-air batteries, lithium-sulphur batteries, lithium-metal accumulators, lithium-ion accumulators, lithium-polymer batteries or lithium-ion capacitors. Preferred are lithium-air batteries, lithium-sulphur batteries and lithium-metal accumulators. The modified and coated metal electrode is particularly suitable for lithium metal accumulators. In preferred embodiments, the electrode according to the invention is an anode. In the sense of the present invention, the term “anode” is to be understood as the negative electrode onto which metallic lithium is deposited.

In a lithium battery or lithium ion accumulator, the electrode described above can be used as the negative electrode. For the positive electrode, a lithium-containing metal oxide or lithium-containing metal phosphate, such as lithium-nickel-manganese-cobalt mixed oxides (NMC), lithium-cobalt oxide (LCO), lithium-nickel oxide (LNO), lithiumnickel-cobalt-aluminum mixed oxides (NCA), lithium-nickel-manganese mixed oxides (LNMO), lithium-iron phosphate (LFP), lithium-iron-manganese phosphate (LFMP), lithium-rich and nickel-rich (Li-rich or Ni-rich) layered oxides applied onto a copper or aluminum film or a metal grid or carbon fleece as a current collector can be used as an active material. In the sense of the present invention, the term “active material” refers to a material that can reversibly absorb and release metal ions, in particular lithium ions, a process which is designated as “insertion” or “intercalation”. The active material thus “actively” participates in the electrochemical reactions that occur during charging and discharging, in contrast to other possible components of an electrode such as a binder, conductive carbon or the current collector. Furthermore, the active material can be an anion-absorbing material, such as graphite or organic p-type materials. In addition, conversion materials such as sulphur or oxygen/air can also be used as a positive electrode.

An electrochemical energy storage device, in particular a lithium or lithium metal battery including an electrode according to the invention, can provide a significantly reduced deposition voltage or deposition resistance. Furthermore, a significant reduction of the cell resistance can be provided. In particular in connection with the use of a non-liquid electrolyte, moreover, the safety of use can be increased.

Preferably, three types of electrolytes can be used as non-liquid electrolytes: solid polymer electrolytes, gel polymer electrolytes and mixed electrolytes of polymer and ceramic electrolyte referred to as hybrid electrolytes. In preferred embodiments, the non-liquid electrolyte comprises a solid polymer electrolyte, a gel polymer electrolyte, or a composite electrolyte comprising a multilayer assembly of a lithium ion-conducting ceramic, vitreous or glass-ceramic solid electrolyte coated on opposing surfaces with a gel polymer electrolyte or a solid polymer electrolyte.

These types of non-liquid electrolytes provide an improved usability of lithium metal as well as a higher safety. The different electrolyte systems each have advantages for different applications. Solid polymer electrolytes can be used in a flexible setup, for example in a pouch setup. Solid polymer electrolytes can preferably be used in a temperature range of 30-80° C. It is of advantage that no organic solvents are used and thus a significantly increased safety can be provided.

The term “gel polymer electrolyte” is to be understood as an electrolyte in which a liquid electrolyte is present in a polymer matrix as an overall gel-like electrolyte. The liquid electrolyte may be a conventional electrolyte based on an aqueous or organic solvent comprising a metal salt, preferably a lithium salt such as LiBOB, LiPF₆, LiBF₄, LiFSI, LiTFSI, LiClO₄, LiDFOB dissolved in an organic carbonate, nitrile, dinitrile, ether, glycol, an ionic liquid or mixtures thereof, wherein the electrolyte may further include known electrolyte additives. Gel polymer electrolytes, too, can be used in flexible setups such as a pouch setup. Gel polymer electrolytes are preferably usable in a temperature range of 0-50° C. In this case, too, it is of advantage that an increased safety can be provided by the non-liquid structure, since the amount of organic or aqueous solvent content is enclosed in the gel membrane.

So-called hybrid electrolytes formed from an inorganic electrolyte and a polymer can be used in particular for high-temperature applications in a range of 40-100° C. Hybrid electrolytes comprising a high proportion of ceramics are particularly suitable for systems with rigid housings such as button cells. Hybrid electrolytes can provide a particularly high level of safety due to only a small proportion of organic or polymeric components.

To produce a cell with solid polymer electrolyte, a structured and coated lithium electrode is provided with a solid polymer electrolyte membrane. In the case of a symmetrical lithium-lithium cell, a solid polymer electrolyte membrane can be placed between two lithium electrodes. In the sense of the present invention, the term “membrane” is to be understood as a thin layer, for example of a polymer electrolyte. The thickness of the polymer membrane may range from ≥10 μm to ≤150 μm, preferably from ≥15 μm to ≤100 μm, more preferably from ≥20 μm to ≤50 μm. In embodiments, the solid polymer electrolyte between the electrodes or the solid polymer electrolyte membrane may be provided via coating the structured surface with a solid polymer electrolyte. In other embodiments, in addition a further solid polymer electrolyte membrane may be arranged between the electrodes in order to increase the layer thickness.

Preferably, as polymers and conducting salts those polymers and conducting salts can be used that are used for the functional coating of the electrode. In this respect, reference is made to the above description for the explanation of the polymers, conducting salts and crosslinking agents. Preferred polymers are selected from the group comprising MEEP, poly((oligo)oxethylene)methacrylate-co-alkali metal methacrylate, MEE-co-BF₃LiP, PEO, PEGDME, SPE, PVdF, PVdF-HFP, PAN, polyester, polypropylene oxide, ethylene oxide/propylene oxide copolymer, PMMA, PMAN, polysiloxane, poly(chlorotrifluoro-ethylene), poly(ethylene-chlorotrifluoro-ethylene) and mixtures thereof. Preferred conducting salts are selected from the group comprising LiBOB, LiPF₆, LiBF₄, LiAsF₆, LiClO₄, LiTFSI, LiFSI, LiDFOB and/or LiTf. A cross-linked mixture of MEEP polymer and LiBOB salt is particularly preferred for a solid polymer electrolyte. The solid polymer electrolyte membrane can be obtained by UV-induced cross-linking by use of a UV-sensitive crosslinking agent of a mixture of the polymer and the lithium salt.

In a cell comprising a gel polymer electrolyte, a gel polymer electrolyte membrane is placed on a structured and coated lithium electrode. In the case of a symmetrical lithium cell, the gel polymer electrolyte can be placed between two lithium electrodes. The thickness of the gel polymer layer may range from ≥10 μm to ≤150 μm, preferably from ≥15 μm to ≤100 μm, more preferably from ≥20 μm to ≤50 μm. As polymers and conducting salts preferably those polymers and conducting salts may be used that are used for the functional coating of the electrode. In this respect, for the explanation of the polymers, conducting salts and cross-linking agents reference is made to the above description. Preferred conducting salts for a gel polymer electrolyte are selected from LiBOB, LiPF₆, LiBF₄, LiAsF₆, LiClO₄, LiTFSI and LiFSI.

For producing a cell comprising a gel polymer electrolyte, a solid polymer electrolyte membrane, for example a cross-linked mixture of MEEP polymer and LiBOB salt, can be arranged on the structured and coated lithium electrode. In a subsequent step a liquid electrolyte can be added thereto. Upon wetting of the solid polymer with the liquid electrolyte, gel formation takes place and results in a leakage-free electrolyte, which thus forms a non-liquid electrolyte. In further embodiments for producing a cell comprising a gel polymer electrolyte, a liquid electrolyte can be disposed onto at least one structured lithium electrode coated with a solid polymer electrolyte and this can be arranged without an additional solid polymer electrolyte membrane on a further structured lithium electrode coated with a solid polymer electrolyte.

As solvents organic solvents, in particular cyclic or linear carbonates, ethers, ethylene glycol dimethyl ether, nitriles, dinitriles as well as ionic liquids are preferred. Preferably, the organic solvent is selected from the group comprising ethylene carbonate (EC), ethyl methyl carbonate (DMC), propylene carbonate, dimethyl carbonate, diethyl carbonate, acetonitrile, propionitrile, 3-methoxypropionitrile, glutaronitrile, adiponitrile, pimelonitrile, gamma-butyrolactone, gamma-valerolactone, dimethoxyethane, 1,3-dioxolane, ethylene glycol dimethyl ether, fluorinated cyclic or linear carbonates, ethers, ionic liquids such as Pyr₁₄TFSI and/or mixtures thereof. Preferably, the solvent is selected from the group comprising ethylene carbonate, ethyl methyl carbonate, dimethyl carbonate, diethyl carbonate and/or mixtures thereof. For example, combinations such as EC:DMC (in a mass ratio of 1:1), EC:DEC (3:7) or EC:EMC (1:1) can be used as solvents for gelation. For example, for producing a gel polymer electrolyte, liquid electrolyte containing 0.7 M LiBOB in EC:DMC (1:1 wt.-%) can be added to the solid polymer electrolyte in a mass ratio of 1:1 during cell construction.

The term “composite” in the sense of the present invention is to be understood as a composite material of two or more materials. Accordingly, the term “hybrid electrolyte” is to be understood as an electrolyte formed from two or more connected materials. In the sense of the present invention, the term “glass ceramic” is to be understood as a material which, starting from a glass basic material produced by melting techniques, is converted in a controlled manner by a specific temperature treatment into a glass ceramic comprising a glass phase and a crystal phase.

Materials are in particular selected from the group comprising lithium-ion-conducting ceramic, vitreous or glass-ceramic solid electrolytes, polymers and lithium salts. Preferred glass-ceramics are lithium compounds having a structure similar to NASICON (NAtrium Super Ionic CONductor, sodium super ion conductor). “Vitreous” electrolytes are to be understood as materials such as lithium phosphate (LIPON) and Li₂S-based oxysulphide glasses.

For producing a cell comprising a hybrid or composite electrolyte, a multilayer assembly of a lithium ion-conducting ceramic, vitreous or glass-ceramic solid electrolyte coated on opposite surfaces with a gel polymer electrolyte or a solid polymer electrolyte is placed on a structured and coated lithium electrode. The multilayer assembly may comprise, for example, a polymer-coated solid electrolyte compact. The solid electrolyte compact, for example a pellet, may for example be formed of LLZO material (Li_{6,6}La₃Zr_{1,6}Ta_{0,4}O₁₂). As described with respect to the functional coating of the lithium electrodes, the pellet can be coated from the two sides with a solid polymer-electrolyte mixture, for example MEEP, LiBOB and benzophenone dissolved in THF, and cross-linked under UV light after drying. In order to produce a multilayer assembly comprising a gel-polymer electrolyte, the solid polymer-electrolyte layer may be gelled with a liquid electrolyte.

In preferred embodiments:
the ceramic solid electrolyte is selected from the group comprising lithium lanthanum zirconate (LLZO) stabilised in a cubic crystal structure by substitution with Ta⁵⁺, Nb⁵⁺, Te⁵⁺ or W⁶⁺ on the Zr⁴⁺ lattice site and/or Al³⁺ or Ga³⁺ on the Li⁺ lattice site, lithium lanthanum tantalum zirconate Li_{6.75}La₃Zr_{1.75}Ta_{0.4}O₁₂ (LLZTO), lithium lanthanum titanate (La,Li)TiO₃ (LLTO), and/or lithium aluminum germanium phosphate Li₁₊ₓAl_{y}Ge_{2-y}(PO₄)₃ (LAGP) where 0.3 x<0.6 and 0.3 y<0.5;
the vitreous solid electrolyte is selected from the group comprising lithium phosphate (LIPON) and/or sulphide-based solid electrolytes selected from the group comprising Li₂S—P₂S₅, Li₃PS₄ (LPS), Li₂S—GeS₂, Li₂S—GeS₂—P₂S₅, Li₂S—GeS₂—ZnS, Li₂S—Ga₂S₃, Li₂S—GeS₂—Ga₂S₃, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—LiI, Li₂S—SiS₂—Li₄SiO₄, Li₂S—SiS₂—Li₃PO₄, Li₂SO₄—Li₂O—B₂O₃ and Li₂S—GeS₂—P₂S₅(LGPS), preferably Li₁₀GeP₂S₁₂; and/or
the glass-ceramic solid electrolyte is selected from the group comprising lithium compounds of the empirical formula Li_{1+x-y}M^{V}_{y}M^{III}ₓM^{IV}_{2-x-y}(PO₄)₃, which are isostructural to NASICON, wherein 0≤x<1.0≤y<1 and (1+x-y)>1 and M^{III} is a trivalent cation, M^{IV} is a tetravalent cation and M^{V} is a pentavalent cation (LATP), in particular Li₁₊ₓAlₓTi₂₋ₓ(PO₄)₃, Li₇P₃S₁₁ and/or Li₇P₂S₈I.

For the lithium compound of the empirical formula Li_{1+x-y}M^{V}_{y}M^{III}ₓM^{IV}_{2-x-y}(PO₄)₃, which is isostructural to NASICON, M^{V} is preferably selected from Ta⁵⁺ and/or Nb⁵⁺, M^{III} is preferably selected from Al³⁺, Cr³⁺, Ga³⁺ and/or Fe³⁺, and/or M^{IV} is preferably selected from Ti⁴⁺, Zr⁴⁺ and/or Si⁴⁺. A preferred lithium compound which is isostructural to NASICON is, for example, lithium aluminum titanium phosphate (LATP), in particular Li₁₊ₓAlₓTi₂₋ₓ(PO₄)₃), such as Li_{1,4}Al_{0,4}Ti_{1,6}(PO₄)₃, which may comprise an ionic conductivity of 6·10⁻³ S/cm as a sintered substrate.

Preferred are ceramic solid electrolytes such as lithium lanthanum zirconates (LLZO) stabilised in a cubic crystal structure by substitution with Ta⁵⁺, Nb⁵⁺, Te⁵⁺ or W⁶⁺ at the Zr⁴⁺ lattice site and/or Al³⁺ or Ga³⁺ at the Li⁺ lattice site, for example Li_{6,6}La₃Zr_{1,6}Ta_{0,4}O₁₂. Preferably, the proportion of substitution is here in the range of 0.4-0.5 per formula unit and/or the proportion of lithium ions per formula unit is ≥6.5. This can contribute to a high conductivity. An advantage of LLZO ceramics is that they are stable to lithium metal. Advantageously, LLZO ceramics with a cubic garnet structure exhibit a high lithium ion conductivity. An advantage of LLZO ceramics is that they are stable to lithium metal. In an advantageous manner, LLZO ceramics exhibit a high lithium ion conductivity. A preferred (La,Li)TiO₃ (LLTO) ceramic is La_{0.57}Li_{0.33}TiO₃. A preferred Li₁₊ₓAl_{y}Ge_{2-y}(PO₄)₃ (LAGP) ceramic is Li_{1.5}Al_{0.5}Ge_{1.5}(PO₄)₃.

The recesses of the metal electrode can be introduced into the metal, for example lithium, by forming processes. The recesses can be formed, for example, by means of rollers, in particular calender rollers or an embossing process. A roller which comprises a positively structured surface corresponding to the recesses can introduce the recesses into a metal film of a desired thickness. Corresponding rollers for large-scale production are available. In particular, large-area microstructured embossing rollers are suitable. The use of microstructured rollers with a large diameter enables a quick and endless embossing of the structures or recesses. Alternatively, a metal film that can be used as an electrode can also be embossed by hand. The rolling or embossing process can be repeated depending on the desired density or number of recesses. In an advantageous manner, the process has the potential for upscaling up to an industrial scale.

Another object of the invention thus relates to a method for producing a metal electrode or a current collector according to the invention for an energy storage device, wherein the structuring of the metal surface with recesses is carried out by a roll-to-roll process.

The surface of the electrode or the current collector comprises a plurality of blind-hole-like recesses spaced apart from each other, and the surface thus structured is coated with a solid polymer electrolyte, wherein the recesses are filled with the solid polymer electrolyte. For the description of the electrode and the current collector, reference is made to the above description.

In the reel-to-reel or roll-to-roll (R2R) process, the starting material is placed on a film roll, is unwound, processed and rewound as a finished product. In this way, a large number of items can be processed cost-effectively, reliably and without problems. Furthermore, rolls with corresponding tip structure can be designed for a roll-to-roll process. Such processes allow for an economical and efficient process on a large scale or by hand, which is able to cover a large surface area by a simple rolling process. In particular, recesses with dimensions in the micrometre range, for example a length, width and/or depth in a range of ≥100 μm to ≤800 μm, can be easily implemented industrially by means of roll-to-roll processes.

The pressure during pressing or rolling of the lithium may be in a range of ≥5 bar to ≤30 bar, preferably from ≥7 bar to ≤20 bar, more preferably from ≥10 bar to ≤15 bar.

In a further step of the method, the structured surface, in particular a lithium surface, can be coated with a solid electrolyte. By a coating with a solid polymer electrolyte, the enlarged surface of the electrode or current collector can be fully used for electrochemical processes. Preferably, a functional coating process is used for this purpose.

The coating can be applied in particular by spray coating, wherein first a mixture or coating solution containing a suitable polymer, such as MEEP, a lithium salt, such as LiBOB, and a crosslinking additive activatable by ultraviolet (UV) rays, such as benzophenone, is prepared in a suitable solvent, such as THF. This mixture can then be applied onto the structured surface, preferably a lithium surface, for example by means of drop coating. By coating with a solution, a homogeneous coating can be formed. As an alternative to THE as a solvent for drop coating, 1,3-dioxolane (DOL), acetonitrile (ACN) or adiponitrile (ADP) can be used. The concentration of the components of the coating mixture such as polymer, lithium salt and crosslinking additive in the solvent may here be in a range of ≥0.15 mg/μl to ≤1 mg/μl, preferably from ≥0.2 mg/μl to ≤0.75 mg/μl, more preferably from ≥0.3 mg/μl to ≤0.5 mg/μl.

The applied coating mixture on the surface of the lithium electrode may be dried at an elevated temperature so that the solvent evaporates. In this case, the drying temperature for the coating may be in a range from ≥50° C. to ≤80° C., preferably from ≥55° C. to ≤75° C., more preferably from ≥70° C. to ≤70° C.

The dried electrode is then preferably irradiated with UV light, whereby the polymer cross-links. This allows a stable coating to be formed. By means of this method, a thin layer of polymer electrolyte can be applied onto the structured lithium electrode so that the layer follows the surface pattern and thereby wets the entire surface. The exposure time for cross-linking the polymer in this case may be in a range from ≥11 minutes to ≤25 minutes, preferably from ≥13 minutes to ≤20 minutes, more preferably from ≥15 minutes to ≤18 minutes.

In an advantageous manner, roll-to-roll processes that can be easily implemented can be used for the structuring, while the coating can be applied by use of simple coating techniques. The processing of the electrode or the current collector can thus be transferred to industrially used systems.

Examples and figures serving the illustration of the present invention are given below.

In the figures:

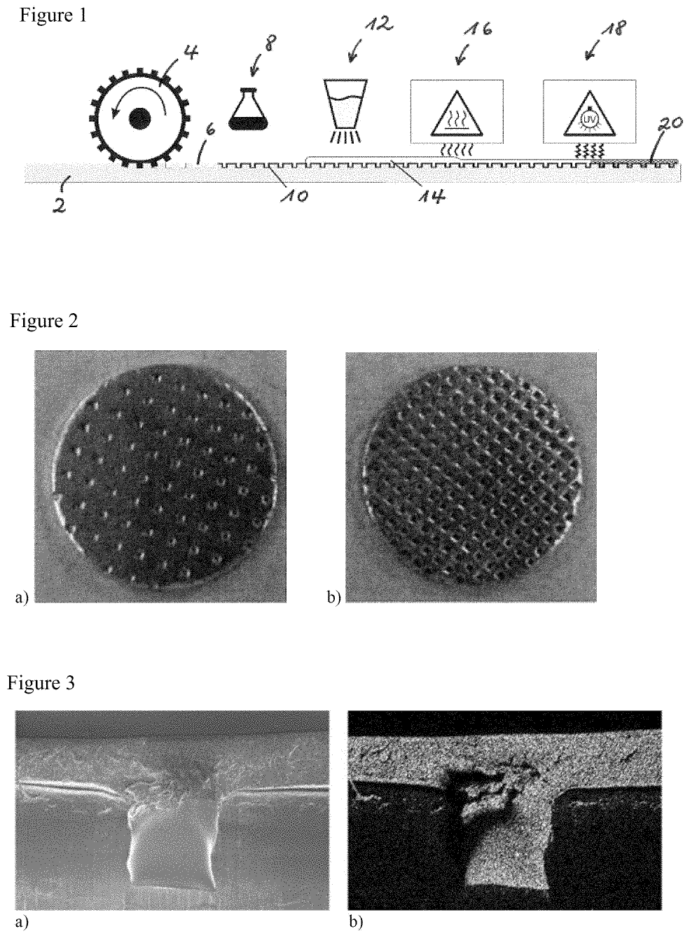

FIG. 1 is a schematic representation of the production or a process for producing a structured, chemically modified metal electrode with a functional coating according to one embodiment of the invention;

FIG. 2 shows mechanically modified lithium metal electrodes, wherein in FIG. 2a) a punch with cuboids in a distance of 1000 μm and in FIG. 2b) a punch with cuboids in a distance of 500 μm was used;

FIG. 3 shows in FIG. 3a) an SEM image of a structured and coated lithium electrode, and in FIG. 3b) an EDS analysis for carbon;

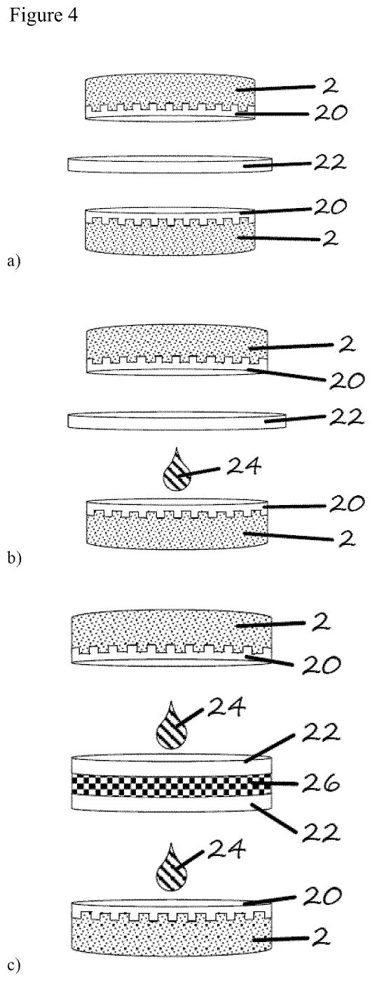

FIG. 4 shows cell structures of energy storage devices comprising a lithium electrode with a structured surface coated with a solid polymer electrolyte as well as non-liquid electrolytes according to various embodiments of the invention as Li/Li symmetrical cells;

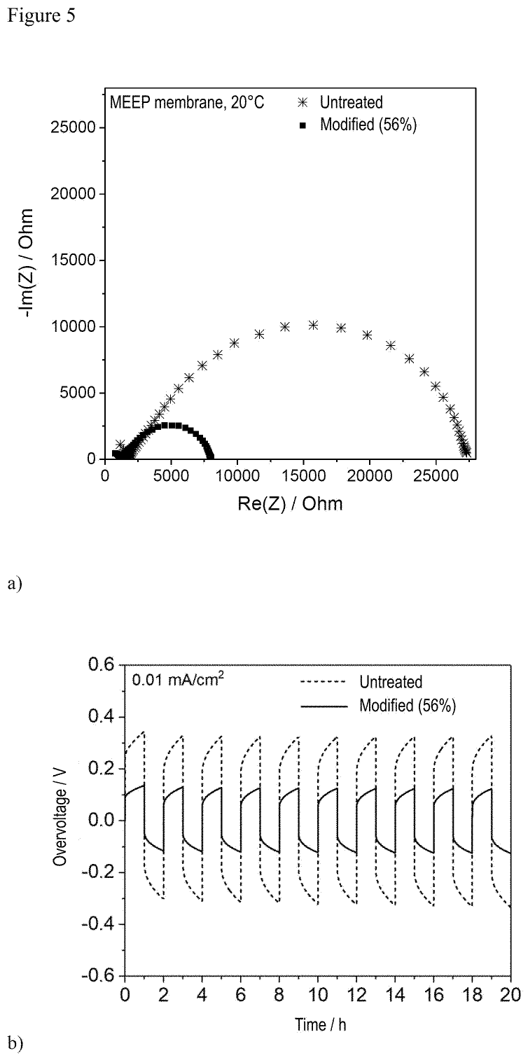

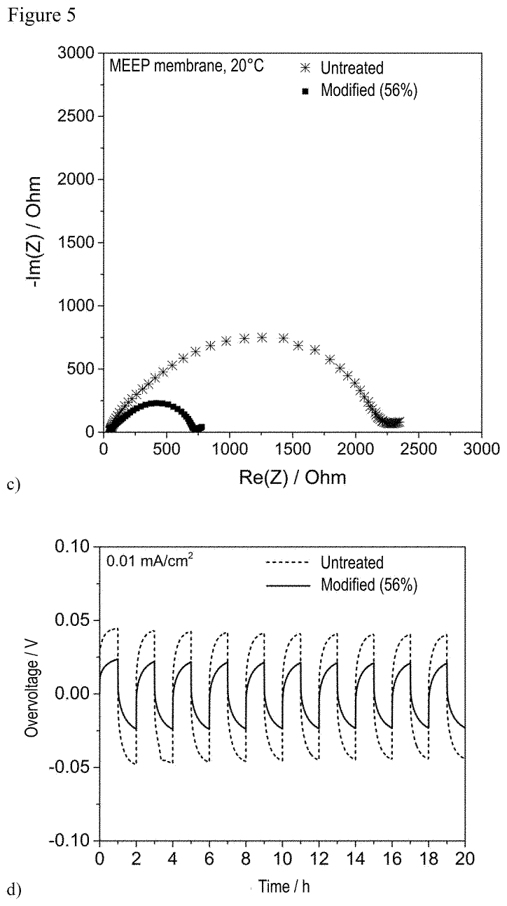

FIG. 5 shows in FIG. 5a) and c) a Nyquist plot for a structured lithium electrode comprising a solid polymer electrolyte (“modified (56%)”, squares) and a reference cell comprising non-structured lithium electrodes (“untreated”, asterisks) and in FIGS. 5b) and d) the corresponding potential profiles measured at 20° C. or 60° C.;

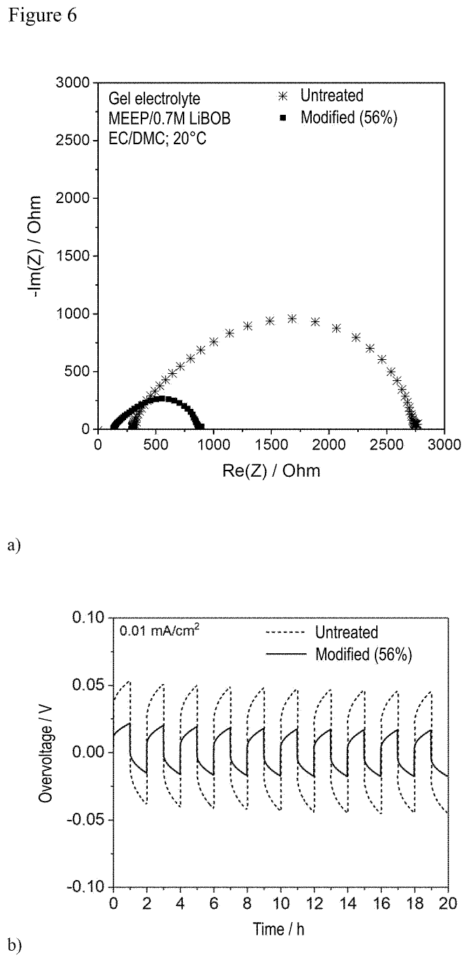

FIG. 6 shows in FIG. 6a) a Nyquist plot for a structured lithium electrode comprising a gel-polymer electrolyte (“modified (56%)” squares) and a reference cell comprising non-structured lithium electrodes (“untreated”, asterisks) and in FIG. 6b) the corresponding potential profiles;

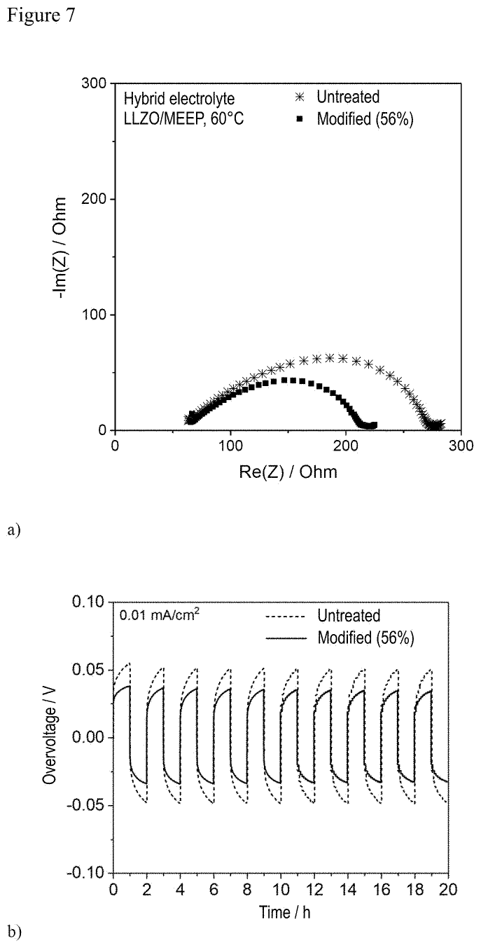

FIG. 7 shows in FIG. 7a) a Nyquist plot for a structured lithium electrode comprising a hybrid electrolyte (“modified (56%)” squares) and a reference cell comprising non-structured lithium electrodes (“untreated”, asterisks) and in FIG. 7b) the corresponding potential profiles;

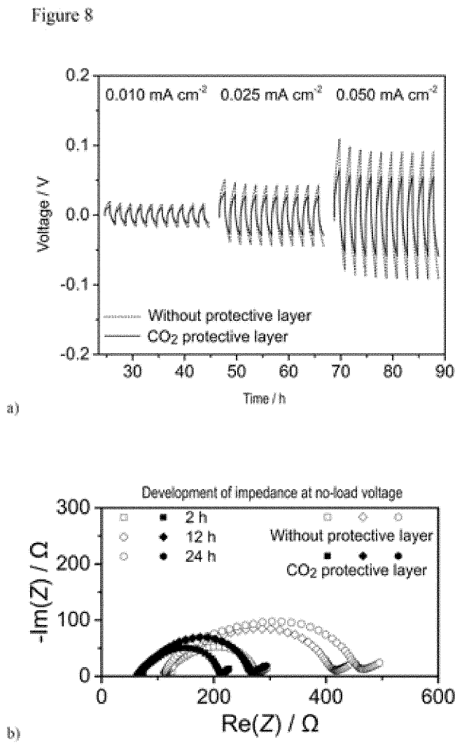

FIG. 8 shows in FIG. 8a) results of the lithium deposition-dissolution experiment and in FIG. 8b) the time evolution of the complex cell resistance in a no-load condition for a symmetrical button cell assembly comprising structured lithium electrodes which were stored in a CO₂ atmosphere and for reference cells;

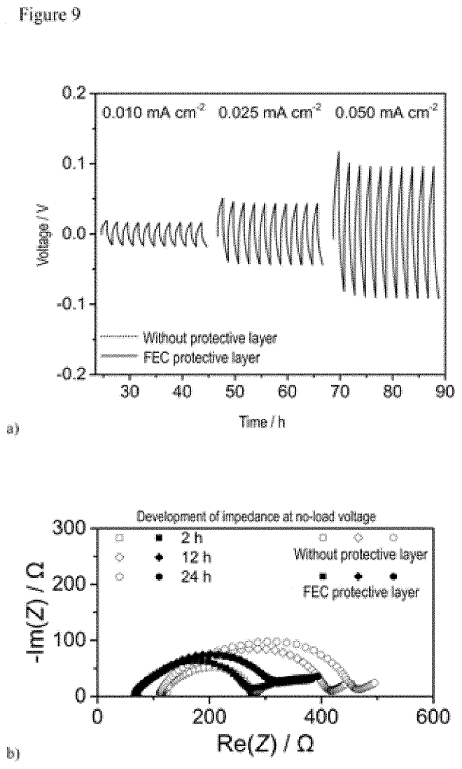

FIG. 9 shows in FIG. 9a) results of the lithium deposition-dissolution experiment and in FIG. 9b) the time evolution of the complex cell resistance in a no-load condition for a symmetrical button cell assembly comprising structured lithium electrodes which were stored in FEC and for reference cells;

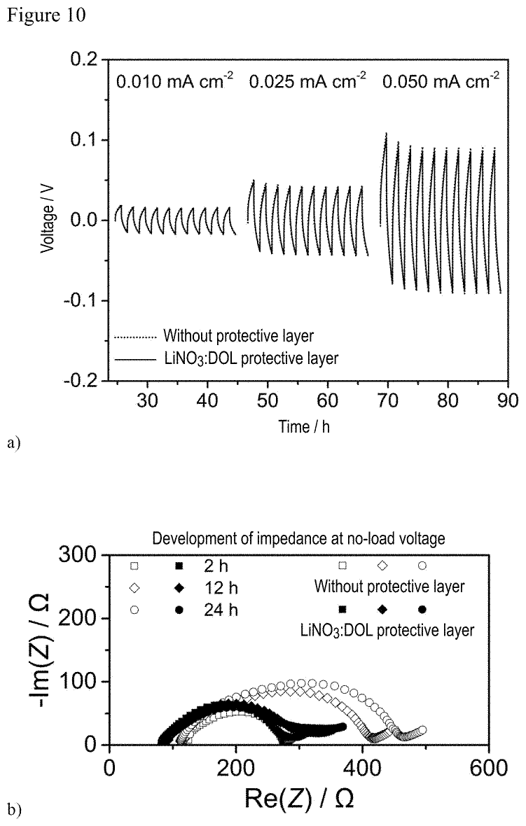

FIG. 10 shows in FIG. 10a) results of the lithium deposition-dissolution experiment and in FIG. 10b) the time evolution of the complex cell resistance in a no-load condition for a symmetrical button cell assembly comprising structured lithium electrodes stored in LiNO₃ in DOL and for reference cells;

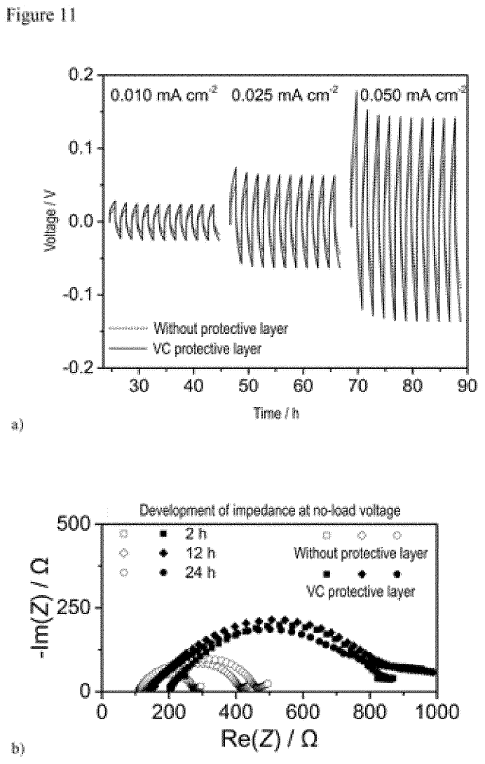

FIG. 11 shows in FIG. 11a) results of the lithium deposition-dissolution experiment and in FIG. 11b) the time evolution of the complex cell resistance in a no-load condition for a symmetrical button cell assembly comprising structured lithium electrodes stored in VC and for reference cells;

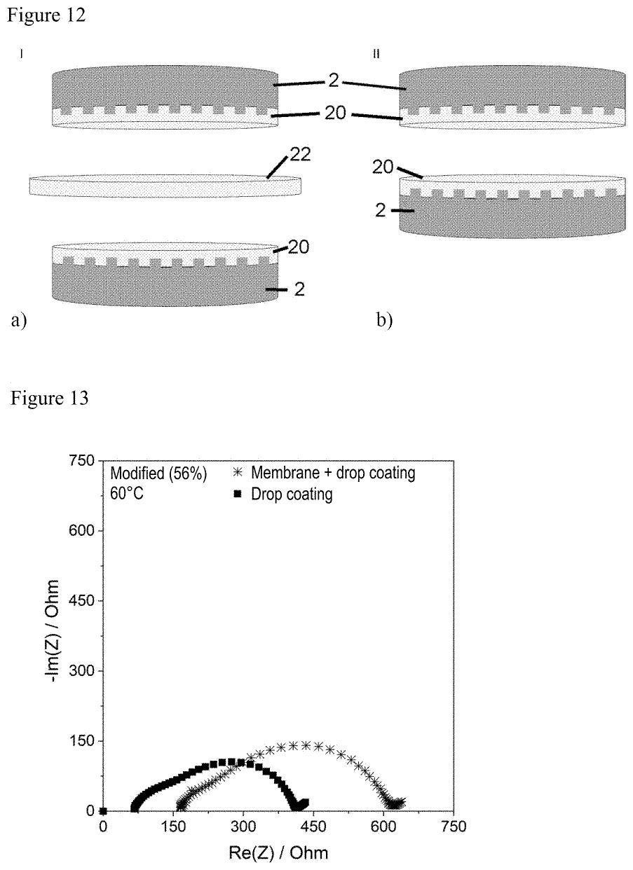

FIG. 12 shows cell structures of energy storage devices comprising a lithium electrode with a structured surface coated with a solid polymer electrolyte with or without an additional polymer electrolyte membrane as Li/Li symmetrical cells;

FIG. 13 shows a Nyquist plot for structured lithium electrodes comprising a solid polymer electrolyte with or without an additional polymer electrolyte membrane;

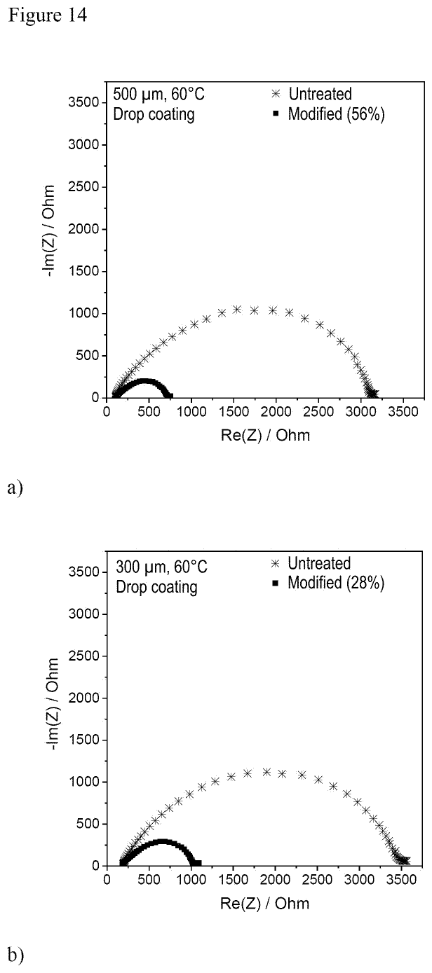

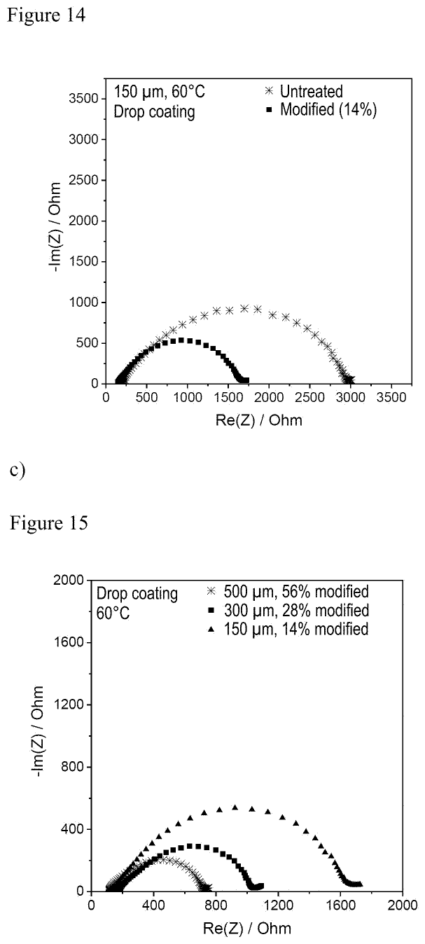

FIG. 14 shows a Nyquist plot of symmetrical cells comprising a solid polymer electrolyte for different electrode thicknesses and depths of recesses against unstructured references;

FIG. 15 shows a Nyquist plot of symmetrical cells comprising a solid polymer electrolyte for different electrode thicknesses and depths of the recesses;

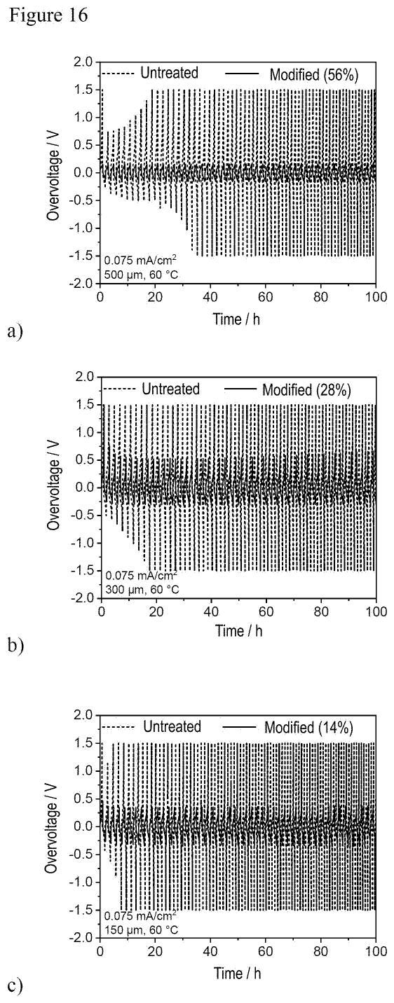

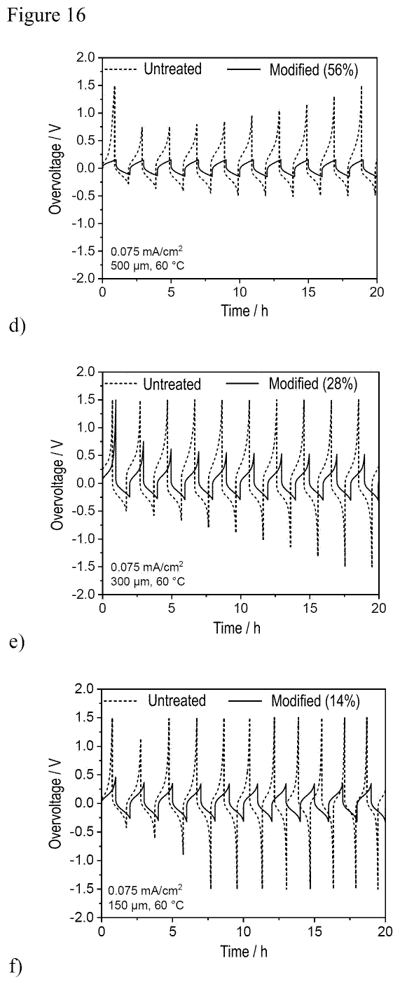

FIG. 16 shows potential profiles at 60° C. and at a current density of 0.075 mA/cm² for structured lithium electrodes comprising a solid polymer electrolyte and for non-structured reference cells; and

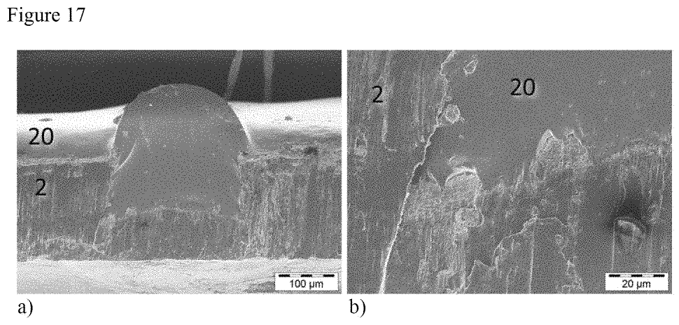

FIG. 17 shows in FIG. 17a) an SEM image of a recess of a depth of 150 μm in a 300 μm thick lithium metal electrode, and in FIG. 17b) an enlarged section.

FIG. 1 shows a schematic view of the process steps in the production of a structured, chemically modified metal electrode comprising a functional coating according to one embodiment of the invention. A metal film 2, for example lithium, is provided in a first step by means of a roller 4, for example by a roll-to-roll process, with a plurality of blind-hole-like recesses 6 spaced apart from each other. In a subsequent step, the surface structured in this way is subjected to a chemical modification 8, wherein by means of contact reactions of the lithium surface for example with carbon dioxide or 1-fluoroethylene carbonate a lithium ion-conducting lithium carbonate layer 10 is formed on the structured surface. In a subsequent step, a coating solution 14 comprising a polymer, a lithium salt and a crosslinking additive activatable by ultraviolet radiation (UV) in a solvent, for example MEEP, LiBOB and benzophenone in THF, is applied onto the structured lithium surface by means of spray coating 12. In a subsequent step, the solvent is removed by drying 16. The dried coating is then irradiated with UV light 18, whereby the polymer cross-links. As a result, the structured surface is coated with a solid polymer electrolyte 20, wherein the recesses 6 are filled with the solid polymer electrolyte 20.

### EXAMPLE 1

Production of Structured Lithium Electrodes with a Functional Coating

1.1 Structuring

A lithium film was structured by pressing a punch onto the lithium surface. Since lithium has a high reactivity with water, the process was carried out in a glovebox under argon atmosphere or in a drying room with dehydrated air. 19 mm wide and 500 μm thick lithium metal strips (Albemarle, thickness 500 μm, purity Battery Grade) were used for the manufacturing of the electrodes. These were machined with punches made of polyoxymethylene (POM), which were provided with regularly arranged small cuboids with the dimensions 300 μm×300 μm×300 μm. The punch was placed on the lithium strip so that the cuboids pointed in the direction of the lithium. A hydraulic press was then used to apply a pressure of 15 bar from above for four to five seconds so that the cuboids left impressions in the soft metal. Two punches were used which differed in their distance between the individual cuboids of 1000 μm (punch 1) and 500 μm (punch 2), so that depending on the punch used, the density of the defects on the lithium was different and thus the surface was enlarged differently. Circular electrodes with a diameter of 12 mm were then punched out of the modified lithium metal strips.

FIG. 2a) shows a lithium metal electrode which was mechanically structured with a punch with cuboids at a distance of 1000 μm (punch 1), FIG. 2b) shows a lithium metal electrode which was mechanically structured with a punch with cuboids at a distance of 500 μm (punch 2). Due to the structuring the entire surface area of the lithium electrode was enlarged by 20% at a distance of 1000 μm and by 56% at a distance of 500 μm relative to the plane surface.

1.2 Coating

The structured lithium surface was then coated with a solid polymer electrolyte. For the coating, a solution of poly[bis((methoxyethoxy)ethoxy)-phosphazene] (MEEP), lithium bis(oxalato)borate (LiBOB) and the UV light-active crosslinking additive benzophenone in tetrahydrofuran (THF) was prepared in a weight ratio of 50:2:3. MEEP, LiBOB and benzophenone were dissolved in tetrahydrofuran (THF) for better homogenisation, which was evaporated under reduced pressure after stirring for one hour. The obtained yellowish, highly viscous solution was stored at 20° C. for further use.

For the drop coating process for coating the electrodes, 100 mg of the viscous non-crosslinked polymer mixture was dissolved in about 300 μl THF, and 60 μl per electrode was dropped evenly onto the lithium electrodes obtained in step 1.1 by use of an Eppendorf pipette. The electrodes were dried overnight in an oven at 65° C. so that the solvent evaporated, and the polymer layer on the structured lithium surface was then crosslinked for 18 minutes under UV light.

The coated lithium electrodes were examined by scanning electron microscopy (SEM, ZEISS Auriga® electron microscope) and EDX analysis (Oxford instruments). FIG. 3a) shows an SEM image of the lithium electrodes with a functional coating mechanically structured with a punch with cuboids at a distance of 500 μm (punch 2). As can be seen in FIG. 3a), the polymer electrolyte coating followed the structure of the lithium surface and covered the entire surface. The polymer layers obtained had a thickness of about 450 μm (±20 μm) including the depth of the recesses. Here, the layer thickness above the filled recesses was about 150 μm. This was also the case for the less structured surface. FIG. 3b) shows the EDX analysis for carbon. As can be seen from FIG. 3b), the carbon was distributed consistently and uniformly in the recesses and the layer, with the exception of voids caused by the embossing. The EDX analysis moreover showed that the elements oxygen and nitrogen as well as phosphorus from the MEEP polymer and boron from the LiBOB salt were respectively present consistently and evenly distributed.

This result shows that by means of the applied method a thin layer of about 150 μm of polymer electrolytes can be deposited on a structured lithium electrode so that the layer follows the surface pattern and thus wets the entire surface.

### EXAMPLE 2

Production of Electrochemical Cells

Cells with three different types of electrolyte were produced: solid polymer electrolyte, gel polymer electrolyte and a hybrid electrolyte formed from a ceramic electrolyte coated on both sides with a gel polymer electrolyte. In all cases, the lithium structuring was carried out by means of the method described in Example 1.1 by use of punch 2 with a 500 μm spacing of the recesses, the coating with solid polymer electrolyte was carried out according to Example 1.2. As reference cells, cells of identical structure with non-structured lithium electrodes, which were identically coated, were respectively produced.

2032 button cells were built for the electrochemical analysis. The cells were built as symmetrical lithium cells. To this end, two coated electrodes were respectively placed on top of each other with the coated side facing each other. In order to avoid a contact between the two electrodes and thus a possible short-circuit of the cell, a non-liquid electrolyte was respectively placed between the electrodes. Other components of the cell structure were spacer plates and a spring washer, which were disposed between the electrodes and the cell housing. These were intended to press the electrodes together sufficiently so that no contact problems between the coatings of the electrodes arised. Depending on the thickness of the combination of electrodes and electrolyte, spacers and springs were adapted.

2.1 Preparation of a Solid Polymer Membrane

The non-crosslinked, highly viscous polymer mixture prepared in Example 1.2 was placed on a siliconized polyester film (Mylar®). A second piece of film was placed on top and the still liquid polymer mixture was spread to form a layer with a thickness of about 150 μm (±20 μm). For crosslinking, the polymer mixture in this form was exposed to UV light for 18 minutes. Subsequently, one of the films could be easily peeled off the crosslinked polymer membrane and small, round membranes of the desired size of 13 mm could be punched out by means of a hole punch. These could be handled with tweezers without any problems.

2.2 Production of a Cell Comprising a Solid Polymer Electrolyte

For cells comprising solid polymer electrolytes, structured lithium electrodes and as a reference non-structured lithium electrodes were first coated according to the procedure described in Example 1.2. In the cells, an additional solid polymer electrolyte membrane made of a crosslinked mixture of MEEP polymer and LiBOB salt according to Example 2.1 was inserted between the lithium electrodes.

FIG. 4a) shows schematically the cell structure, wherein a structured lithium electrode 2 comprising a solid polymer electrolyte coating 20 was respectively used as anode and cathode and a solid polymer electrolyte membrane 22 was used as non-liquid electrolyte.

2.3 Production of a Cell Comprising a Gel-Polymer Electrolyte

For cells comprising gel-polymer electrolytes, structured lithium electrodes and as a reference non-structured lithium electrodes were first coated according to the process described in Example 1.2. In the cells, an additional solid polymer electrolyte membrane made of a crosslinked mixture of MEEP polymer and LiBOB salt according to Example 2.1 was inserted between the lithium electrodes. In order to produce a gel polymer electrolyte therefrom, liquid electrolyte made from 0.7 M LiBOB in EC:DMC (1:1 wt.-%) was added to the solid polymer electrolyte in a mass ratio of 1:1 during cell construction. Wetting of the solid polymer with the liquid electrolyte caused gelation of the polymer and resulted in a leakage-free gel electrolyte. This is thus defined as non-liquid.

FIG. 4b) shows schematically the cell structure, wherein a structured lithium electrode 2 comprising a solid polymer electrolyte coating 20 was respectively used as anode and cathode, and a gel polymer electrolyte resulted from the application of a solid polymer electrolyte membrane 22 made of a crosslinked mixture of MEEP polymer and LiBOB salt and a liquid electrolyte 24.

2.4 Production of a Cell Comprising a Hybrid Electrolyte

For the cells comprising a hybrid electrolyte, lithium electrodes were coated as described above. A polymer-coated solid electrolyte compact consisting of a 400 μm thick layer of LLZO material (Al-doped Li_{6.6}La₃Zr_{1.6}Ta_{0.4}O₁₂, Jülich Research Centre) coated on both sides with an approximately 100 μm thick layer of the gel-polymer electrolyte was placed between the electrodes. The gel-polymer coated solid electrolyte was prepared analogous to the coating of the electrodes by drop-coating the LLZO material on both sides with the non-crosslinked polymer mixture of MEEP polymer, LiBOB salt and benzophenone dissolved in THE as a crosslinker and crosslinking under UV light after drying. In order to produce a gel polymer from the solid polymer layer on the LLZO material, liquid electrolyte consisting of 0.7 M LiBOB in a mixture of ethylene carbonate and dimethyl carbonate (EC:DMC, 1:1 wt.-%) was respectively added in a mass ratio of 1:1 to the total solid polymer electrolyte amount between the polymer solid electrolyte pellet and the lithium electrode during cell construction.

FIG. 4c) schematically shows the cell structure, wherein a structured lithium electrode 2 comprising a solid polymer electrolyte coating 20 was respectively used as anode and cathode. A pellet of LLZO material 26 coated on both sides with a solid polymer electrolyte membrane 22 made of a crosslinked mixture of MEEP polymer and LiBOB salt was impregnated with a liquid electrolyte 24, resulting in a double-sided coating with a gel polymer electrolyte.

### EXAMPLE 3

Electrochemical Characterisation of a Cell Comprising a Solid Polymer Electrolyte

The cells comprising structured and coated lithium electrodes comprising a solid polymer electrolyte produced according to example 2.1 and the reference cell comprising non-structured lithium electrodes were compared with each other by means of impedance measurements and cycling experiments (lithium dissolution/deposition).

The electrochemical investigations were carried out in 2032 button cells. The cells were assembled in a glovebox (MBraun) filled with an inert gas atmosphere of argon. A constant current density of 0.01 mA/cm² was applied during the cycling, wherein a lithium deposition occurred on the one electrode and a lithium dissolution on the other. The subsequent polarisation on the electrodes was measured as an overvoltage. The current direction was reversed after one hour. The measurement was made between −1.5 V and 1.5 V (termination criterion of the cell voltage) at 20° C. and 60° C. The results at 20° C. are shown in FIGS. 5a) and 5b), the results at 60° C. in FIGS. 5c) and 5d).

FIG. 5a) shows the Nyquist plot of the structured and coated lithium electrode comprising a solid polymer electrolyte (“modified (56%)” squares) and the reference cell comprising non-structured lithium electrodes (“untreated”, asterisks). As can be seen in FIG. 5a), the impedance measurement showed a significant reduction in resistance with the lithium structuring for the cells comprising the solid polymer electrolyte. Further tests using lithium electrodes the surface of which was formed with recesses at a distance of 1000 μm and thus had a surface area enlarged by 20%, also showed a significant reduction in resistance, which was slightly lower in comparison. This shows that the higher the structure density and thus the larger the lithium surface area, the more the resistance decreased. It is assumed that the larger surface area of the electrode facilitates the electrochemical reactions at the surface and the overvoltage reduces.

FIG. 5b) shows the potential profiles of the structured lithium electrode comprising a solid polymer electrolyte (“modified (56%)”) and the reference cell comprising non-structured lithium electrodes (“untreated”). The deposition/dissolution experiments also showed a reduction in the overvoltage due to the lithium structuring. Again, further comparative experiments with the less structured surface showed that the denser the structuring and thus the larger the surface area, the greater the effect.

FIGS. 5c) and d) show that the surface resistance and the overpotentials are lower than at 20° C., which means a better ionic conductivity.

### EXAMPLE 4

Electrochemical Characterisation of a Cell Comprising a Gel-Polymer Electrolyte

The cell comprising structured and coated lithium electrodes and gel polymer electrolyte produced according to Example 2.2 and the reference cell comprising non-structured lithium electrodes were investigated by means of impedance measurements and cycling experiments (lithium dissolution/deposition) as described in Example 3, wherein the measurement was carried out at 20° C.

FIG. 6a) shows the Nyquist plot of the structured and coated lithium electrode comprising a gel polymer electrolyte (“modified (56%)” squares) and the reference cell comprising non-structured lithium electrodes (“untreated”, asterisks). As can be seen in FIG. 6a), a significant reduction in resistance was also achieved with the lithium structuring for the cells comprising the gel polymer electrolyte. Accordingly, a significant reduction in overvoltage was also obtained in the deposition/dissolution experiments shown in FIG. 6b).

### EXAMPLE 5

Electrochemical Characterisation of a Cell Comprising a Hybrid Electrolyte

The cell comprising structured and coated lithium electrodes comprising a hybrid electrolyte consisting of LLZO solid electrolyte coated on both sides with a 100 μm thick layer of gel polymer electrolyte, produced according to Example 2.3, and the reference cell comprising non-structured lithium electrodes were investigated by means of impedance measurements and cycling experiments (lithium dissolution/deposition) as described in Example 3. The measurements were carried out at 60° C.

FIG. 7a) shows the Nyquist plot for the cell comprising a hybrid electrolyte and structured and coated lithium electrodes (“modified (56%)” squares) and the reference cell comprising non-structured lithium electrodes (“untreated”, asterisks). As can be seen in FIG. 7a), similar to the solid and gel-polymer electrolytes, a significant reduction of the interfacial resistance was also obtained for the cells comprising the hybrid electrolyte. Accordingly, a reduction in overvoltage was also achieved in the deposition/dissolution experiments shown in FIG. 7b).

### EXAMPLE 6

Chemical Coating of the Structured Lithium Electrode by Treating with CO₂ Gas

Furthermore, the effect of a chemical protective layer, a so-called “artificial SEI” on the structured lithium electrodes was investigated. These support the longevity of the batteries and potentially increase safety. For this purpose, lithium was mechanically processed as described in Example 1.1, wherein recesses at a distance of 500 μm and thus an enlargement of the surface area by 56% was used. The structured electrode was then stored in pure CO₂ for three weeks. The electrode was then coated as described in Example 1.2.

For an electrochemical investigation of the effects of the formed carbonate protective layer, symmetrical button cells comprising a solid polymer electrolyte membrane were prepared from a crosslinked mixture of MEEP polymer and LiBOB salt between the lithium electrodes as described in Example 2.2, and impedance measurements and cycling experiments were performed. As reference cells, structured lithium electrodes stored for three weeks in a drying room under water exclusion were used.

Cyclings were performed at constant current densities of 0.01 mA/cm², 0.025 mA/cm² and 0.05 mA/cm². The subsequent polarisation on the electrodes was measured as overvoltage. The current direction was reversed after one hour. The measurement was made in a range between −1.5 V and 1.5 V (termination criterion of the cell voltage) at 60° C. The results are shown in FIGS. 8a) and 8b).

FIG. 8a) shows the results of the lithium deposition-dissolution experiment and FIG. 8b) the time evolution of the complex cell resistance in a no-load condition for the symmetrical button cell assembly comprising structured lithium electrodes with 56% surface enlargement, functional coating with MEEP polymer and solid polymer membrane, for structured electrodes which were stored in a CO₂ atmosphere and for reference cells comprising electrodes without enriched carbonate layer. The comparison shows that in the case of a treatment with CO₂ gas, a reduced overvoltage occurred, as can be seen in FIG. 8a), and reduced surface resistances were found, as can be seen in FIG. 8b).

These results show that by a treatment with CO₂ gas the overvoltages as well as the surface resistance were further reduced. Thus, the protective layer formed by contact with CO₂ shows a further improvement.

### EXAMPLE 7

Chemical Coating of the Structured Lithium Electrode by Layer Formation Additives

Furthermore, the effect of a chemical protective layer formed from the known additives vinylene carbonate (VC) and 1-fluoroethylene carbonate (FEC) as well as lithium nitrate was investigated. To this end, structured lithium electrodes were stored for two days in vinylene carbonate, 1-fluoroethylene carbonate or 10 wt.-% lithium nitrate dissolved in 1,3-dioxolane. For reference cells, structured lithium electrodes were stored for two days in a drying room under exclusion of water. Subsequently, symmetrical button cells comprising a solid polymer electrolyte membrane were prepared as described in Example 6 and impedance measurements and cycling experiments were carried out.

FIG. 9a) shows the results of the lithium deposition-dissolution experiment and FIG. 9b) the time evolution of the complex cell resistance in a no-load condition for the symmetrical button cell assembly comprising structured lithium electrodes with 56% surface enlargement, functional coating with MEEP polymer and solid polymer membrane which were stored in FEC and for the reference cell comprising electrodes without FEC layer. The comparison shows that in the case of the FEC coating, unchanged overvoltages occurred, as can be seen in FIG. 9a), but reduced surface resistances could be found, as can be seen in FIG. 9b). Although the overvoltages for FEC storage were identical to those for the reference electrode, the effect is most noticeable in the surface tension. After 24 h, this was half that of the mechanically structured cell without FEC coating. This can be explained by a layer with the characteristic of an increased lithium transport number.

FIG. 10a) shows the results of the lithium deposition-dissolution experiment and FIG. 10b) the time evolution of the complex cell resistance in a no-load condition for the symmetrical button cell assembly comprising structured lithium electrodes stored in LiNO₃:DOL and for the reference cell. The comparison shows that, as can be seen in FIG. 10a), slightly reduced overvoltages occurred in the case of the LiNO₃:DOL storage and reduced surface resistances could be found, as can be seen in FIG. 10b).

The combination of LiNO₃ and 1,3-dioxolane thus also shows an improved behaviour compared to the non-chemically modified structured electrode. In particular, there was a difference in the case of the surface resistance, which was already constant after the construction of the cell. This indicates an already well passivated lithium surface.

In contrast, as is shown in FIGS. 11a) and 11b), the cell exhibited increased overvoltages and increased surface resistances after storage of the lithium electrodes in vinylene carbonate. Vinylene carbonate thus produced a layer on lithium that exhibited an increased resistance. This can be explained by the formation of a thicker layer or a layer of more polymeric components. Vinylene carbonate can thus be classified as less advantageous in terms of resistance and overvoltages compared to the other substances, but may be favoured in the case of a flexible protective layer.

Altogether, by the combination with a chemical coating of the structured, in particular microstructured, electrode a lithium surface with further modified properties can thus be obtained. Among the examples shown, CO₂ could be identified as the best chemical modification.

### EXAMPLE 8

Comparison of Cells Comprising a Solid Polymer Electrolyte of Different Thicknesses

A cell comprising a solid polymer electrolyte was prepared as described in Example 2.2 by coating structured lithium electrodes by use of a stamp 2 (cuboid 300 μm×300 μm×300 μm, 500 μm spacing, resulting in 56% enlargement in surface area) according to the procedure described in Example 1.2 and inserting a solid polymer electrolyte membrane made of a crosslinked mixture of MEEP polymer and LiBOB salt according to Example 2.1 between the electrodes.

Another cell with a smaller amount of solid polymer electrolyte was prepared by omitting the use of the additional polymer electrolyte membrane between the electrodes.

Thus, the thickness of the polymer electrolyte resulted exclusively from the two electrode coatings (drop coating).

FIG. 12a) schematically shows the cell structure 1, which corresponds to that shown in FIG. 4a), wherein respectively a structured lithium electrode 2 comprising a solid polymer electrolyte coating 20 was used as anode and cathode and a solid polymer electrolyte membrane 22 was used as non-liquid electrolyte. FIG. 12b) shows a corresponding cell structure II without an additional solid polymer electrolyte membrane.

The electrochemical tests were carried out in 2032 button cells as described in example 3. FIG. 13 shows the Nyquist plot for the structured lithium electrodes comprising a solid polymer electrolyte in the form of a membrane in addition to the electrode coating (“membrane+drop coating”, asterisks, scheme 1) as well as for the cell structure only comprising an electrode coating (“drop coating”, squares, scheme 1l) measured at 60° C. As can be seen in FIG. 13, the lower amount of electrolyte resulted in a reduction of the charge transfer resistance.

This shows that also embodiments in which the solid polymer electrolyte is formed between the structured electrodes only by combining the two thin layers on the structured lithium electrode show good results.

### EXAMPLE 9

Comparison of Different Depths of the Recesses in the Lithium Electrodes

The change in the depth of the recesses in the lithium electrodes and the associated change in the surface enlargement of the metal electrodes was investigated. Here, the electrode material, which was modified by structurings, was also reduced in the form of thinner lithium metal electrodes. To this end, the originally 500 μm thick lithium film (Albemarle) was rolled out to 300 μm and 150 μm, respectively, in a press process (roll pressing).

For the mechanical modification of the lithium electrodes, new block press punches with adapted dimensions were used. While the punch 2 with the block dimensions of 300 μm×300 μm×300 μm and a block spacing of 500 μm was used for the 500 μm thick lithium film, a punch 3 with the block dimensions of 150 μm (height)×300 μm×300 μm and a punch 4 with the block dimensions of 75 μm (height)×300 μm×300 μm were used for the 300 μm thick lithium film. The following table 1 summarizes the parameters of the structuring:

TABLE 1
Dimensions of the punches, corresponding surface enlargements and
thickness of the lithium film

| | Punch 2 | Punch 3 | Punch 4 |
|---|---|---|---|
| Block hight | 300 μm | 150 μm | 75 μm |
| Block spacing | 500 μm | 500 μm | 500 μm |
| Surface enlargement | 56% | 28% | 14% |
| Lithium thickness | 500 μm | 300 μm | 150 μm |

The correspondingly manufactured cells comprising structured and coated lithium electrodes comprising a solid polymer electrolyte and a reference cell comprising a non-structured lithium electrode of corresponding thickness were compared with each other by means of impedance measurements as described in example 3 at 60° C.

The Nyquist plot in FIG. 14 shows the symmetrical cells comprising a solid polymer electrolyte for an electrode thickness of 500 μm and recesses of a depth of 300 μm in FIG. 14a), 300 μm and a depth of 150 μm in FIG. 14b) and 150 μm and a depth of 75 μm in FIG. 14c) respectively against the unstructured reference cell. The Nyquist plots shown in FIG. 14 show a reduction in resistance for the structured cells (squares) compared to the unstructured reference cells for each of the structurings. However, this effect becomes weaker the less deep the recess was, since in this case the enlargement in surface area was smaller. This is also shown by the direct comparison of the different modified electrodes in FIG. 15. The 150 μm thick electrode structured with 75 μm deep recesses and 14% enlarged surface area exhibited a significantly higher resistance than the other two, while the 500 μm thick electrode with 300 μm deep recesses exhibited the lowest resistance value.

Furthermore, cycling experiments (electrochemical lithium dissolution/deposition) were performed with symmetrical cells comprising modified and unmodified lithium metal electrodes. FIG. 16 shows the potential profiles at 60° C. and a current density of 0.075 mA/cm² for the respective structured lithium electrodes comprising a solid polymer electrolyte (“modified”, solid line) and the respective reference cell comprising unstructured lithium electrodes (“untreated”, dashed line) for an electrode thickness of 500 μm and recesses of a depth of 300 μm in FIG. 16a), 300 μm and a depth of 150 μm in FIG. 16b) and 150 μm and a depth of 75 μm in FIG. 16c) over a period of 100 hours. FIGS. 16d), e) and f) respectively show the overvoltage for the first 20 hours for the electrode thickness of 500 μm and recesses of a depth of 300 μm, 300 μm and a depth of 150 μm and 150 μm and a depth of 75 μm.

As can be seen in FIG. 16, the cells comprising unmodified electrodes partially directly reached the specified overvoltage limit of 1.5 V at a current density of 0.075 mA/cm² and a temperature of 60° C., irrespective of their thickness, which immediately resulted in the termination of the charging or discharging process. In comparison, the modified electrodes showed a constantly lower overpotential of a maximum of approx. 0.6 V for the electrodes with 300 μm lithium and 300 μm recesses and approx. 0.3 V for the 150 μm lithium film with 75 μm recesses over the first 50 cycles. Thus, the mechanical modification also seems to increase the cycling stability and the lifetime of the cell.

The cycled electrodes were then analyzed by use of a scanning electron microscope. FIG. 17a) shows the cross-section through the recess of a depth of 150 μm in a 300 μm thick lithium metal electrode. Here, the polymer-coated side faces upwards. FIG. 17b) shows an enlarged detail. FIG. 17a) shows that the recess has been filled very well with the polymer. Thus, the drop coating process can also be applied to thinner lithium electrodes. Above the recess, moreover a bulge can be seen in the polymer. It is assumed that the polymer was pressed there upwards by lithium deposited in the recess. Overall, it can be seen that the lithium has been deposited uniformly predominantly in the recess. In the enlarged view of FIG. 17b) it can be seen that the lithium was nevertheless not only deposited homogeneously in the recess. Lithium deposits with a higher surface area, which protrude into the polymer, were also formed on the wall and bottom of the recess.

These results show that the amount of polymer electrolyte applied by drop coating alone was sufficient to wet the entire electrode. An additional membrane can extend the lifetime of the cell by acting as a barrier, but at the same time can increase the electrolyte resistance in the cell. Furthermore, it could be shown that the drop-coating and block-press process can also be applied to thinner lithium electrodes. Recesses of 75 μm, 150 μm and 300 μm showed good wetting by the polymer and by means of the modification impedances and overpotentials could be reduced. The polymer electrolyte ensured a largely uniform deposition of the lithium.

The invention on which this patent application is based was developed in a project supported by the BMBF under the promotional references 03XP0084A and 03XP0084C.

1. Metal electrode or current collector for an energy storage device, wherein a surface of the metal electrode or the current collector comprises a plurality of blind-hole-like recesses spaced apart from each other, wherein the surface structured in this way is coated with a solid polymer electrolyte, wherein the blind-hole-like recesses are filled with the solid polymer electrolyte.

2. Metal electrode or current collector according to claim 1, wherein the structured surface of the metal electrode is enlarged in a range from ≥20% to ≤200% with respect to an area of the same dimension with a planar surface.

3. Metal electrode or current collector according to claim 1, wherein the blind-hole-like recesses have a length, width and/or depth in a range from ≥100 μm to ≤800 μm.

4. Metal electrode or current collector according to claim 1, wherein the solid polymer electrolyte is a polymer selected from the group comprising poly[bis((methoxyethoxy)ethoxy)phosphazene], poly((oligo)oxethylene)methacrylate-co-alkali metal methacrylate, poly[bis((methoxyethoxy)ethoxy)-co-(lithium-trifluoro-oxoborane)polyphosphazene], polyethylene oxide, polystyrene-b-poly(ethylene oxide), polyvinylidene fluoride, poly(vinylidene fluoride-co-hexafluoropropylene), polyacrylonitrile, polyester, polypropylene oxide, ethylene oxide/propylene oxide copolymer, polymethyl methacrylate, polymethylacrylonitrile, polysiloxane, poly(chlorotrifluoro-ethylene), poly(ethylene-chlorotrifluoro-ethylene) and mixtures thereof.

5. Metal electrode or current collector according to claim 1, wherein the solid polymer electrolyte forms a layer having a layer thickness in a range from ≥5 μm to ≤150 μm.

6. Metal electrode or current collector according to claim 1, wherein the metal is lithium, wherein the structured lithium surface has a chemical modification, selected from a lithium ion conductive layer containing lithium carbonate which is prepared by contact reactions of a lithium surface with carbon dioxide, 1-fluoroethylene carbonate (FEC), vinylene carbonate (VC) or lithium nitrate in 1,3-dioxolane.

7. Primary or secondary energy storage device comprising a current collector or, as a negative electrode (anode), a metal electrode according to claim 1, a non-liquid electrolyte and a counter electrode, as a positive electrode.

8. Energy storage device according to claim 7, wherein the non-liquid electrolyte comprises:
a solid polymer electrolyte;
a gel polymer electrolyte; or
a composite electrolyte comprising a multilayer assembly of a lithium ion-conducting ceramic, vitreous or glass-ceramic solid electrolyte coated on opposite surfaces with a gel polymer electrolyte or a solid polymer electrolyte.

9. Energy storage device according to claim 8, wherein:
the ceramic solid electrolyte is selected from the group comprising lithium lanthanum zirconate (LLZO) stabilised in a cubic crystal structure by substitution with Ta⁵⁺, Nb⁵⁺, Te⁵⁺0 or W⁶⁺ at the Zr⁴⁺ lattice site and/or Al³⁺ or Ga³⁺ at the Li⁺ lattice site, lithium lanthanum tantalum zirconate Li_{6.75}La₃Zr_{1.75}Ta_{0.4}O₁₂ (LLZTO), lithium lanthanum titanate (La,Li)TiO₃ (LLTO), and/or lithium aluminum germanium phosphate Li₁₊ₓAl_{y}Ge_{2-y}(PO₄)₃ (LAGP), wherein 0.3 x<0.6 and 0.3 y<0.5;
the vitreous solid electrolyte is selected from the group comprising lithium phosphate (LIPON) and/or sulphide-based solid electrolytes selected from the group comprising Li₂S—P₂S₅, Li₃PS₄ (LPS), Li₂S—GeS₂, Li₂S—GeS₂—P₂S₅, Li₂S—GeS₂—ZnS, Li₂S—Ga₂S₃, Li₂S—GeS₂—Ga₂S₃, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—LiI, Li₂S—SiS₂—Li₄SiO₄, Li₂S—SiS₂—Li₃PO₄, Li₂SO₄—Li₂O—B₂O₃ and Li₂S—GeS₂—P₂S₅ (LGPS); and/or
the glass-ceramic solid electrolyte is selected from the group comprising lithium compounds of the empirical formula Li_{1+x-y}M^{V}_{y}M^{III}ₓM^{IV}_{2-x-y}(PO₄)₃ isostructural to NASICON, wherein 0≤x<1, 0≤y<1 and (1+ x-y)>1 and M^{III} is a trivalent cation, M^{IV} is a tetravalent cation and M^{V} is a pentavalent cation (LATP, in particular Li₁₁₊ₓAlₓTi₂₋ₓ(PO₄)₃), Li₇P₃S₁₁ and/or Li₇P₂S₈I.

10. Method of producing a metal electrode or a current collector for an energy storage device according to claim 1, wherein the structuring of the metal surface with recesses is carried out by a roll-to-roll process.

11. Metal electrode or current collector according to claim 1 wherein the structured surface of the metal electrode is enlarged in a range from ≥30% to ≤150% with respect to an area of the same dimension with a planar surface.

12. Metal electrode or current collector according to claim 1, wherein the structured surface of the metal electrode is enlarged in a range from ≥50% to ≤100%, with respect to an area of the same dimension with a planar surface.

13. Metal electrode or current collector according to claim 1, wherein the blind-hole-like recesses have a length, width and/or depth in a range from ≥200 μm to ≤500 μm.

14. Metal electrode or current collector according to claim 1, wherein the blind-hole-like recesses have a length, width and/or depth in a range from ≥300 μm to ≤400 μm.

15. Metal electrode or current collector according to claim 1, wherein the solid polymer electrolyte forms a layer having a layer thickness in a range from ≥15 μm to ≤100 μm.

16. Metal electrode or current collector according to claim 1, wherein the solid polymer electrolyte forms a layer having a layer thickness in a range from ≥20 μm to ≤50 μm.
